(19) United States
(12) Patent Application Publication
(10) Pub. No.: US 2021/0027263 A1
(43) Pub. Date: Jan. 28, 2021

(54) INFORMATION PROCESSING APPARATUS, DOCUMENT CREATING METHOD, AND RECORDING MEDIUM

(71) Applicant: Takaaki HIROI, Tokyo (JP)

(72) Inventor: Takaaki HIROI, Tokyo (JP)

(73) Assignee: Ricoh Company, Ltd., Tokyo (JP)

(21) Appl. No.: 16/931,863

(22) Filed: Jul. 17, 2020

(30) Foreign Application Priority Data
Jul. 24, 2019 (JP) 2019-136373

(51) Int. Cl. G06Q 20/10; G06Q 20/32; G06Q 20/36; G06Q 20/38

(52) U.S. Cl. CPC G06Q 20/105; G06Q 20/3278; G06Q 20/389; G06Q 20/363; G06Q 20/3223

(57) ABSTRACT

An information processing apparatus includes circuitry; and a memory storing computer-executable instructions that cause the circuitry to receive an action history of a user via a network from a mobile terminal recording the action history; and create a document based on the action history.

### CROSS-REFERENCE TO RELATED APPLICATION

The present application is based on and claims priority under 35 U.S.C. § 119 to Japanese Patent Application No. 2019-136373, filed on Jul. 24, 2019, the contents of which are incorporated herein by reference in their entirety.

### BACKGROUND OF THE INVENTION

### 1. Field of the Invention

The present invention relates to an information processing apparatus, a document creating method, and a recording medium.

### 2. Description of the Related Art

When an employee of a company and the like travels on business, he or she may pay advance money for transportation expenses and then request for reimbursement for the transportation expenses after returning to the office. Further, in the event of a meeting with the customer at the business trip destination, the employee may submit minutes to his or her workplace. Further, in recent years, there have been many cases in which employees work without coming to the office. In such cases, the employee may create and submit a daily report to the company.

This kind of paperwork is a burden on employees. Accordingly, a technology has been devised for reducing the burden on employees and supporting the creation of accurate transportation expense reimbursement documents according to the actual action of the users such as employees (see, for example, Patent Document 1). Patent Document 1 discloses a system in which a mobile information terminal stores the action history information of a user, and an information processing apparatus creates a form related to the action of a user using the action history information transmitted from the mobile information terminal.

Patent Document 1: Japanese Unexamined Patent Application Publication No. 2005-215866

### SUMMARY OF THE INVENTION

According to one aspect of the present invention, there is provided an information processing apparatus including circuitry; and a memory storing computer-executable instructions that cause the circuitry to receive an action history of a user via a network from a mobile terminal recording the action history; and create a document based on the action history.

### BRIEF DESCRIPTION OF THE DRAWINGS

FIG. 1 is a diagram illustrating an outline of an operation of an information processing system according to an embodiment of the present invention;

FIG. 2 is a configuration diagram of an example of the information processing system according to an embodiment of the present invention;

FIG. 3 is a hardware configuration diagram illustrating an example of a mobile terminal according to an embodiment of the present invention;

FIG. 4 is a hardware configuration diagram illustrating an example of an information processing apparatus according to an embodiment of the present invention;

FIG. 5 is a hardware configuration diagram illustrating an example of a communication apparatus according to an embodiment of the present invention;

FIG. 6 is a functional block diagram illustrating examples of functions of a mobile terminal, a communication apparatus, and an information processing apparatus in block shapes according to an embodiment of the present invention;

FIG. 7 is a sequence diagram illustrating a procedure in which an information processing system creates each document from a user's action history according to an embodiment of the present invention;

FIG. 8 illustrates an example of a transportation expense reimbursement document according to an embodiment of the present invention;

FIG. 9 illustrates an example of a daily report according to an embodiment of the present invention;

FIG. 10 illustrates an example of minutes according to an embodiment of the present invention;

and

FIG. 11 illustrates an example of a work record according to an embodiment of the present invention.

### DETAILED DESCRIPTION OF THE PREFERRED EMBODIMENTS

The conventional technology has a problem that it is not possible to create documents when the user is outside the company's office, such as at an outing destination. For example, the conventional technology requires communication between an information processing apparatus in which a system is installed and a mobile terminal, and documents cannot be created outside the company's office, such as at an outing destination.

A problem to be addressed by an embodiment of the present invention is to provide an information processing apparatus or the like that is capable of automatically creating various documents even when a user is outside the company's office, such as at an outing destination.

Hereinafter, as an example of an embodiment of the present invention, an information processing system and a document creation method performed by the information processing system will be described with reference to the drawings.

### <Outline of Operation>

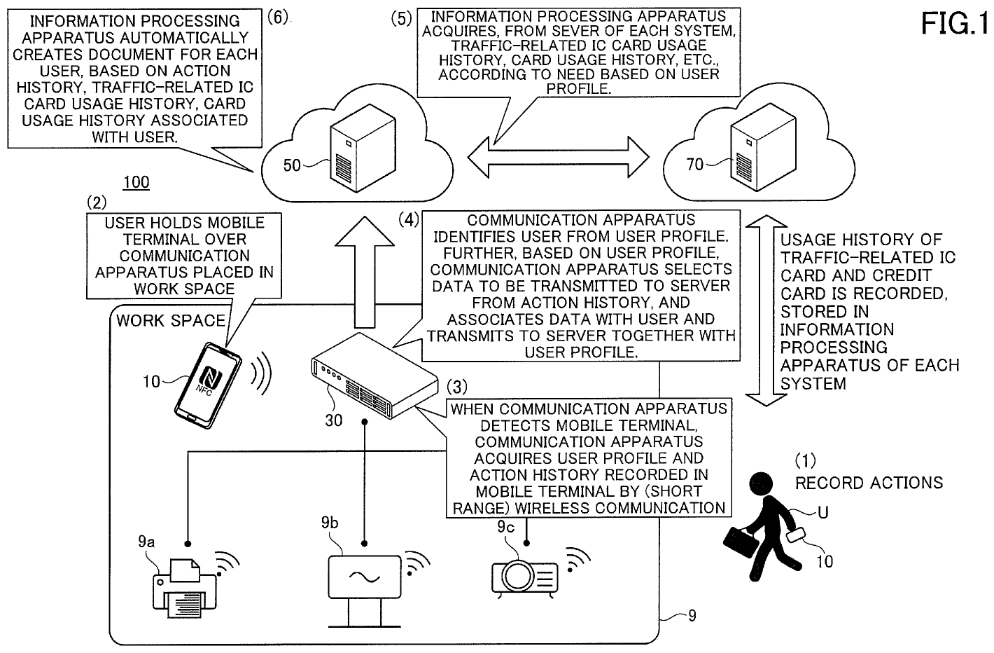

FIG. 1 is a diagram illustrating an outline of an operation of an information processing system 100 according to the present embodiment. The user is an employee of a company and the like and carries a mobile terminal 10 when performing actions outside of the company's office. User actions include all actions to be reported to the company, such as movements, meetings, paperwork, and the like, which are performed primarily for carrying out the work. In FIG. 1, a work space 9 is a location other than the office of the company to which the user belongs. The work space 9 is located outside of the company's office, and includes a coworking space, a rental office, home SOHO, a coffee shop, in a car and the like. The work space 9 is included in the outing destination. The company's office is the location of the user's workplace determined by the company to which the user belongs. The user of the present embodiment performs the work not only in the company's office but also in the work space 9.

(1) The user's action history is recorded in the mobile terminal 10. The usage history of a traffic-related integrated circuit (IC) card or a credit card used by the user during the user's action is recorded and stored in a billing related server 70 of each system. The usage history may also be recorded and stored in the mobile terminal 10.

(2) The user who has returned to the work space 9 holds the mobile terminal 10 over a communication apparatus 30 installed in the work space 9.

(3) Upon detection of the mobile terminal 10, the communication apparatus 30 receives the user profile and the action history of the user recorded in the mobile terminal 10 through short range wireless communication.

(4) The communication apparatus 30 identifies a user by the user profile. Further, the communication apparatus 30 selects the data to be transmitted to the server among the action history based on the user profile, and transmits the user profile and the action history to an information processing apparatus 50 in association with the identification information of the user.

(5) Based on the user profile, the information processing apparatus 50 acquires, as needed, the usage history of using the traffic-related IC card, the usage history of using the credit card, and the like, from the billing related server 70 of each system. The term “as needed” means that if the action history includes the usage history of using the traffic-related IC card (traffic-related IC card usage history) and the usage history of using the credit card (credit card usage history), it is not necessary to acquire this information from the billing related server 70.

(6) The information processing apparatus 50 automatically creates documents for each user based on the action history, the traffic-related IC card usage history, and the credit card usage history associated with the user. Documents may include, for example, transportation expense reimbursement documents, daily reports, minutes, and work records.

As described above, according to the present embodiment, processes of automatically creating a variety of documents can be performed even when a person is outside the company's office, such as an outing destination. The communication apparatus 30 can prevent the increase in the amount of communication by determining the document for which the function of the document creation processing is enabled based on the user profile, selecting only the action history required for the document creation processing, and transmitting the selected action history to the information processing apparatus 50.

FIG. 1 illustrates the case in which the traffic-related IC card usage history and the credit card usage history are recorded in each billing related server 70 that is separate from the information processing apparatus 50 communicating with the communication apparatus 30. However, the information processing apparatus 50 may include information on the usage history of the respective cards.

By installing the communication apparatus 30 in the work space 9, even when the person is outside the company's office, such as an outing destination, a variety of documents can be automatically created while avoiding an increase in the amount of communication by selecting the process of creating a document to be automatically performed.

### Terminology

The action history is a record of what the user has done primarily for performing work. The action history is electronic data and electronic files, etc.

A document is electronic data or a file in which various kinds of information are described. The document may be printed on paper.

### <Example of System Configuration>

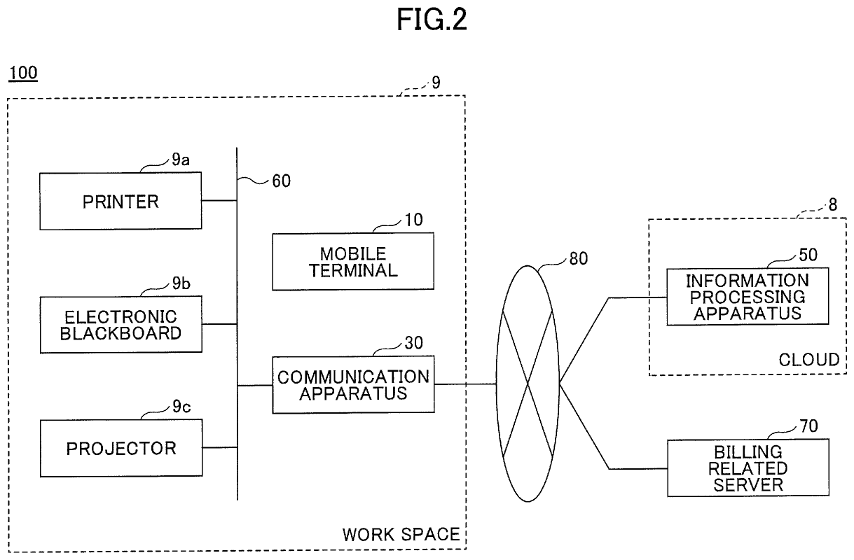

FIG. 2 is a diagram illustrating an example of the information processing system 100 according to the present embodiment. In the information processing system 100 of FIG. 2, a cloud 8 and the work space 9 are connected via a network 80, such as the Internet. The work space 9 is a location where the user works outside the company's office, as described above. A user is an employee of a company, the local government, other organizations, an educational institution, an administrative agency, etc. In the work space 9, a printer 9a, an electronic blackboard 9b, a projector 9c, and the communication apparatus 30 are connected via a network 60 such as a Local Area Network (LAN). Further, one or more information processing apparatuses 50 in the cloud 8 are connected to the network 80.

The network 80 is implemented by one or more LANs connected by a router or the like. The network 60 may be part of the Internet. A communication network, such as a cellular line, may be included.

The printer 9a, the electronic blackboard 9b, and the projector 9c are electronic devices used by a user for work. Examples of electronic devices that are commonly used in offices are illustrated. In the present embodiment, there may be no electronic devices.

Further, there may be a Multifunction Peripheral/Product/Printer (MFP), a video conference device, a camera, industrial or home devices with communication functions, medical devices with communication functions, and the like.

The communication apparatus 30 is one of the information processing apparatuses that communicates with the mobile terminal 10 and with the information processing apparatus 50 in the cloud 8. For example, the communication apparatus 30 communicates with the mobile terminal 10 by short range wireless communication and with the information processing apparatus 50 in the cloud via the network 80.

The communication apparatus 30 may be, for example, a Personal Computer (PC), a tablet PC, a television set, a telephone, a smartphone, a router, or the like. Further, the above-described electronic devices may also serve as communication devices, thus saving the work space 9.

In a state where the user has returned to the work space 9, the mobile terminal 10 is present in the work space 9. The mobile terminal 10 records the action history of the user in real time and transmits the action history and the user profile to the communication apparatus 30 by short range wireless communication. For example, communication is performed by Near Field Communication (NFC) and Bluetooth (registered trademark). Communication may be performed via wire, such as a Universal Serial Bus (USB) cable. The user profile is described later, but the user profile may include user identification information and information specifying documents to be created by the user.

The mobile terminal 10 is an information processing terminal that can be carried by a user. For example, a smartphone, a mobile phone, a Personal Digital Assistant (PDA), a notebook PC, or the like may be used, provided that the action history can be recorded. For example, the mobile terminal 10 may be an apparatus that can record location information using a Global Navigation Satellite System (GNSS) and record actions using a user-set schedule. Thus, the mobile terminal 10 may be a game machine, an e-book reader, a wearable PC (e.g., a wristwatch or sunglass type), a car navigation system, or the like.

The information processing apparatus 50 automatically creates various documents upon receiving the user profile and the action history from the communication apparatus 30. Automatically create means that the information acquired from the action history is written in the format (template) of each document. Full completion is not required and modifications and additions may be made by the user. Documents to be created include, but are not limited to, transportation expense reimbursement, daily reports, minutes of meetings, and work records.

The documents created by the information processing apparatus 50 are transmitted to the user by e-mail or to a predetermined destination of the company to which the user belongs based on the user profile. For example, transportation expense reimbursement documents are transmitted to the General Affairs Section, daily reports are transmitted to the Supervisor, minutes are transmitted to the Supervisor, and work records are transmitted to the Human Resources Department. The e-mail addresses and folders of these transmission destinations are determined respectively.

The billing related server 70 is a server that manages the traffic-related IC card usage history and the credit card usage history. For example, if the information processing apparatus 50 logs in by using a user's account, the usage history of each user can be acquired. As described above, when the mobile terminal 10 stores the usage history, the billing related server 70 is not required.

The configuration of the information processing system 100 illustrated in FIG. 2 is an example, and one or more server apparatuses (such as a proxy server or a gateway server) may be interposed between the work space 9 and the information processing apparatus 50. The information processing apparatus 50 of FIG. 2 may be implemented by being divided into two information processing apparatuses 50.

### <Example of Hardware Configuration>

### <<Mobile Terminal>>

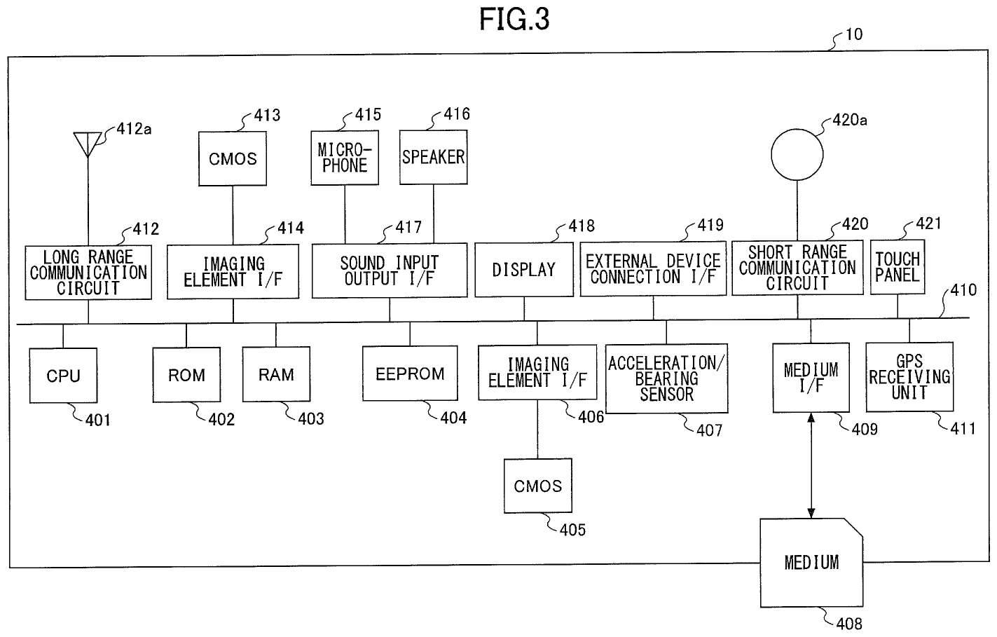

FIG. 3 is a diagram illustrating a hardware configuration of the mobile terminal 10. As illustrated in FIG. 3, the mobile terminal 10 includes a central processing unit (CPU) 401, a read-only memory (ROM) 402, a random access memory (RAM) 403, an EEPROM 404, a complementary metal-oxide semiconductor (CMOS) sensor 405, an imaging element interface (I/F) 406, an acceleration/bearing sensor 407, a medium I/F 409, and a global positioning system (GPS) receiving unit 411.

Among these, the CPU 401 controls the operation of the entire mobile terminal 10. The ROM 402 stores the CPU 401 and programs used to drive the CPU 401, such as the initial program loader (IPL). The RAM 403 is used as the work area of the CPU 401. The EEPROM 404 reads out or writes various kinds of data, such as a mobile terminal program, according to the control of the CPU 401. The CMOS sensor 405 is a type of built-in imaging means that captures a subject (mainly a self-image) according to the control of the CPU 401 to obtain image data. The CMOS sensor 405 may be an imaging means, such as a Charge Coupled Device (CCD) sensor, instead of a CMOS sensor. The imaging element I/F 406 is a circuit that controls the driving of the CMOS sensor 405. The acceleration/bearing sensor 407 is a variety of sensors, such as an electromagnetic compass and a gyrocompass which detect geomagnetic fields, and an acceleration sensor. The medium I/F 409 controls the reading or writing (storage) of data to a recording medium 408, such as a flash memory. The GPS receiving unit 411 receives the GPS signal from the GPS satellite.

Further, the mobile terminal 10 includes a long range communication circuit 412, a CMOS sensor 413, an imaging element I/F 414, a microphone 415, a speaker 416, a sound input output I/F 417, a display 418, an external device connection I/F 419, a short range communication circuit 420, an antenna 420a of the short range communication circuit 420, and a touch panel 421.

Among these, the long range communication circuit 412 is a circuit for communicating with other devices via the network 80. The CMOS sensor 413 is a type of built-in imaging means that captures a subject according to the control of the CPU 401 and obtains image data. The imaging element I/F 414 is a circuit that controls the driving of the CMOS sensor 413. The microphone 415 is a built-in circuit that converts sound to an electrical signal. The speaker 416 is a built-in circuit that converts electrical signals to physical vibrations to produce sound, such as music and speech. The sound input output I/F 417 is a circuit that processes the input and output of sound signals between the microphone 415 and the speaker 416 according to the control of the CPU 401. The display 418 is a type of display means such as a liquid crystal display or an organic Electro Luminescence (EL) display for displaying an image of a subject or various icons. The external device connection I/F 419 is an interface for connecting various external devices. The short range communication circuit 420 is a communication circuit such as a Near Field Communication (NFC) or Bluetooth (registered). The touch panel 421 is a type of input means for operating the mobile terminal 10 when a user presses the display 418.

The mobile terminal 10 also includes a bus line 410. The bus line 410 is an address bus, data bus, or the like for electrically connecting elements such as the CPU 401 illustrated in FIG. 3.

### <<Information Processing Apparatus>>

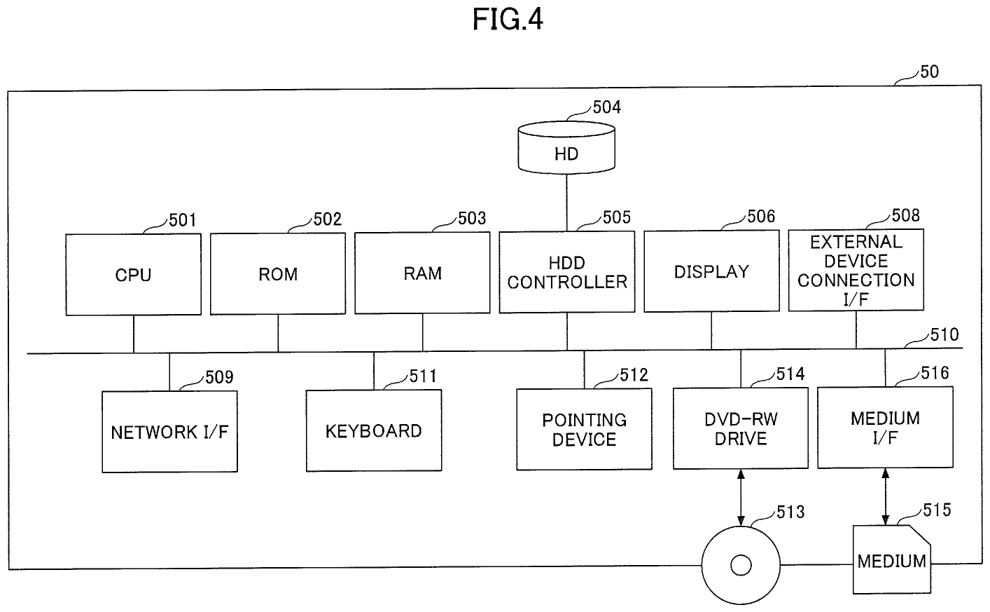

FIG. 4 is a hardware configuration diagram of the information processing apparatus 50. As illustrated in FIG. 4, the information processing apparatus 50 is constructed by a computer and includes a CPU 501, a ROM 502, a RAM 503, a hard disk (HD) 504, a hard disk drive (HDD) controller 505, a display 506, an external device connection I/F 508, a network I/F 509, a bus line 510, a keyboard 511, a pointing device 512, a Digital Versatile Disk Rewritable (DVD-RW) drive 514, and a medium I/F 516, as illustrated in FIG. 4.

Among these, the CPU 501 controls the operation of the entire information processing apparatus 50. The ROM 502 stores a program used to drive the CPU 501, such as an IPL. The RAM 503 is used as the work area of CPU 501. The HD 504 stores various kinds of data such as a program. The HDD controller 505 controls the reading or writing of various kinds of data to the HD 504 according to the control of the CPU 501. The display 506 displays various kinds of information such as cursors, menus, windows, characters, or images. The external device connection I/F 508 is an interface for connecting various external devices. In this case, the external device may be, for example, a Universal Serial Bus (USB) memory or a printer. The network I/F 509 is an interface for performing data communication using the network 80. The bus line 510 is an address bus, a data bus, or the like for electrically connecting elements such as the CPU 501 illustrated in FIG. 4.

The keyboard 511 is a type of input means with a plurality of keys for input of characters, numbers, various instructions, and the like. The pointing device 512 is a type of input means for selecting and executing various instructions, selecting a processing target, moving a cursor, and the like. The DVD-RW drive 514 controls the reading or writing of various kinds of data to the DVD-RW 513 as an example of a removable recording medium. The DVD-RW drive 514 is not limited to a DVD-RW, but may be a Digital Versatile Disc Recordable (DVD-R), etc. The medium I/F 516 controls the reading or writing (storage) of data to a recording medium 515, such as a flash memory.

### <<Communication Apparatus>>

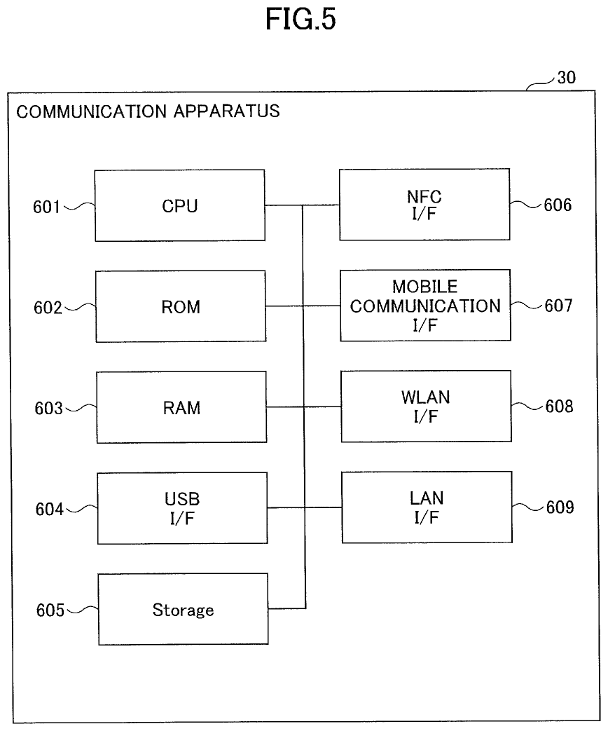

FIG. 5 is an example of a hardware configuration diagram of the communication apparatus 30. As illustrated in FIG. 5, the communication apparatus 30 is constructed by a computer and includes a CPU 601, a ROM 602, a RAM 603, a USB I/F 604, a storage 605, an NFC I/F 606, a mobile communication I/F 607, a Wireless LAN (WLAN) I/F 608, and a LAN I/F 609.

Among these, the CPU 601 controls the operation of the entire communication apparatus 30. The ROM 602 stores a program used to drive the CPU 601, such as an IPL. RAM 603 is used as the work area of CPU 601. The storage 605 stores various kinds of data such as a program. The USB I/F 604 is an interface for connecting a USB memory and external I/O devices (keyboard, mouse, etc.). The NFC I/F 606 is a communication interface that performs short range wireless communication with the mobile terminal 10. The NFC I/F 606 is also a reader/writer of an IC card. Infrared communication or visible optical communication is possible.

The mobile communication I/F 607 is a communication interface that connects to public wireless communication (cellular line) such as 3G/4G (LTE)/5G. The mobile communication I/F 607 can be used when the communication apparatus 30 cannot be connected to the network 60. The WLAN I/F 608 is a communication interface of a wireless LAN for communicating with neighboring network devices. The LAN I/F 609 is a wired LAN interface for communicating with neighboring network devices.

### <Functions>

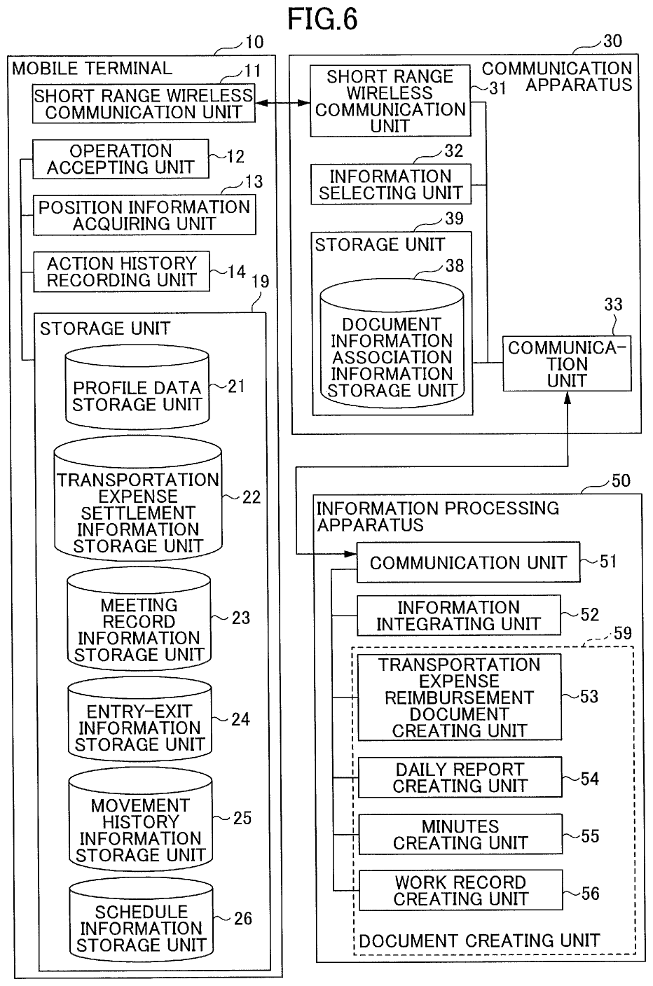

Next, the functions and data of the mobile terminal 10, the communication apparatus 30, and the information processing apparatus 50 that are included the information processing system 100 will be described with reference to FIG. 6. FIG. 6 is an example of a functional block diagram illustrating functions of the mobile terminal 10, the communication apparatus 30, and the information processing apparatus 50 in block shapes.

### <<Mobile Terminal>>

The mobile terminal 10 includes a short range wireless communication unit 11, an operation accepting unit 12, a position information acquiring unit 13, and an action history recording unit 14. Each of these functions of the mobile terminal 10 is a function or means implemented by executing, by the CPU 401, a program (an information management application) loaded from the EEPROM 404 to the RAM 403 illustrated in FIG. 3.

The short range wireless communication unit 11 communicates with the communication apparatus 30 in a wireless manner. When the mobile terminal 10 enters a range within which the radio wave of the short range wireless communication of the communication apparatus 30 reaches, the mobile terminal 10 transmits data in response to a request from the communication apparatus 30. In the present embodiment, the user profile and the action history are transmitted.

The operation accepting unit 12 accepts various operations of a user with respect to the mobile terminal 10. For example, the operation accepting unit 12 accepts the document to be created, the action history to be recorded, the date of issuance of each document, and the transmission destination of each document.

The position information acquiring unit 13 regularly acquires position information (latitude, longitude, and altitude) detected by the GPS receiving unit 411 by controlling the GPS receiving unit 411.

The action history recording unit 14 records various action histories in a storage unit 19. The storage unit 19 includes a profile data storage unit 21, a transportation expense settlement information storage unit 22, a meeting record information storage unit 23, an entry-exit information storage unit 24, a movement history information storage unit 25, and a schedule information storage unit 26 implemented by the EEPROM 404, the ROM 402, or the RAM 403 illustrated in FIG. 3. These are described below.

TABLE 1

| | |
|---|---|
| IDENTIFICATION | U001 |
| INFORMATION OF USER | |
| AUTOMATIC CREATION | TRANSPORTATION |
| DOCUMENT | EXPENSE REIMBURSEMENT |
| | DOCUMENT |
| | DAILY REPORT |
| | MINUTES |
| | WORK RECORD |

Table 1 schematically illustrates a user profile stored in the profile data storage unit 21. A user profile is information about an automatic creation document associated with the user's identification information. The automatic creation document is a document to be automatically created, and the automatic creation document is created by the information processing apparatus 50.

The user sets in advance, in the mobile terminal 10, the information to be recorded as the action history and the automatic creation documents (the documents to be automatically created: for example, processing of transportation expenses, creation of daily reports, creation of meeting minutes, input of work records, etc.), by using an information management application. The information to be recorded as the action history varies depending on the automatic creation document, and, therefore, a setting method may be performed in which the necessary action history is presented upon selecting an automatic creation document, and the user approves of the information to be recorded as the action history. When the user has input the information to be recorded as the action history in advance, a setting method may be performed by presenting the automatic creation document that can be created with the input information. The association between the information recorded by the mobile terminal 10 as the action history and the automatic creation document, is described with reference to Table 7.

The user's identification information may be information that uniquely specifies or identifies the user, e.g., an employee number, a user ID, a telephone number, or a mail address. The identification information of the user can be pre-registered using the information management application. For example, the information management application provides an operation screen and accepts the registration of the identification information of the user and the setting of another automatic creation document and the like via the operation screen displayed on the mobile terminal 10.

TABLE 2A

| | | | | REMAIN- | |
|---|---|---|---|---|---|
| | | | | ING | TRAV- |
| | | | | AMOUNT | ELLING |
| | | | LOCATION | OF MONEY | EXPENSE |
| 20xx/05/15 | hh/mm | ENTRY | STATION A | 9800 | 200 |
| | hh/mm | EXIT | STATION B | | |
| 20xx/05/10 | hh/mm | ENTRY | STATION C | 10000 | 350 |
| | hh/mm | EXIT | STATION D | | |

TABLE 2B

| | | | NAME OF | AMOUNT OF |
|---|---|---|---|---|
| DATE | | | STORE USED | MONEY |
| 20xx/mm/dd | hh/mm | ENTRY | TOMEI X | 2500 |
| | | | INTERCHANGE | |
| | hh/mm | EXIT | TOMEI Y | |
| | | | INTERCHANGE | |
| 20xx/mm/dd | hh/mm | | ◯◯TAXI | 1780 |

Table 2A schematically illustrates the usage history of a traffic-related IC card stored in the transportation expense settlement information storage unit 22. The traffic-related IC card usage history refers to the usage history of using a traffic-related IC card. With respect to the date and time, the station that the user has entered, the station that the user has left, the balance (remaining amount of money) at that time, and the transportation expense are recorded. Not only the station name, but also the means of transportation, such as the railway (route name) may be described.

Table 2B schematically illustrates the credit card usage history stored in the transportation expense settlement information storage unit 22. The credit card usage history refers to the usage history of using a credit card. With respect to the date and time, the name of the shop and the amount of money are recorded. The highway fares are also recorded in the credit card usage history. Entry and exit can be recorded, for example, by a credit card compatible with the Electronic Toll Collection System (ETC).

As described above, the action history recording unit 14 records the traffic-related IC card usage history and the credit card usage history (transportation means (taxis, toll roads, etc.)) when using the transportation network. These usage histories are examples of the action histories managed by the information management application.

The information management application may have a transportation expense settlement function, or the user may manually input the usage history, which is settled by another transportation expense settlement application, by using the information management application. Further, the information management application may acquire the usage history that is stored and managed by another transportation expense settlement application within the mobile terminal 10, or may acquire the usage history from the billing related server 70 of the traffic-related IC card.

The traffic-related IC card usage history is recorded in the server of the traffic-related IC card system, and, therefore, it is not necessarily required to record the traffic-related IC card usage history in the mobile terminal 10. In this case, the mobile terminal 10 transmits not only the user profile and the action history, but also the account information such as the user ID and the password for logging in to the billing related server 70 (the server of the traffic-related IC card) to the communication apparatus 30. However, the information processing apparatus 50 may store the account information for logging in to the billing related server 70 as the basic setting of the user. In this case, the mobile terminal 10 may transmit only the user profile and the action history to the communication apparatus 30.

TABLE 3

| SUBJECT | DATE AND | MEETING | | VOICE |
|---|---|---|---|---|
| MATTER | TIME | PARTY | LOCATION | SOUND DATA |
| NEW SYSTEM | 20xx/05/15 | COMPANY A | COMPANY A | ***.mp3 |
| BRIEFING | 10:00~11:00 | Mr. a | | |
| ACCOMMODATE | 20xx/05/10 | COMPANY B | COMPANY B | ***.mp3 |
| CLAIMS | 15:00~16:00 | Mr. b | | |
| . . . | . . . | . . . | . . . | . . . |

Table 3 schematically illustrates the meeting record information stored in the meeting record information storage unit 23. The subject matter, the date and time, the meeting party (the person to meet), the location, and voice sound data are recorded in the meeting record information. Voice sound data is data that is obtained by recording the conversation between the user and the other party at the meeting.

For example, when the position information indicates that movement is resumed after staying at a certain location for a certain period of time or more, the action history recording unit 14 acquires the schedule overlapping with the staying time from the schedule information storage unit 26 and records the schedule in the meeting record information. When voice sound data is recorded during the staying time, the schedule will be stored in association with the voice sound data.

Alternatively, upon completion of recording the voice sound data, the action history recording unit 14 acquires the schedule that overlaps the time period during which the voice sound data has been recorded and records the schedule as the meeting recording information in association with the voice sound data.

In any case, when the work space 9 or the company's office is the staying location (the location at which the user has stayed) (can be determined from location information), the schedule may be excluded from the creation of the meeting record information.

In any case, the user may add or modify information in the meeting record information. Further, when there is no record in the schedule information, a user interface for inputting the meeting record information may be displayed to prompt the user input upon resuming the movement after staying at a certain location or after completion of recording the voice sound data.

Meeting record information is an example of the action history managed by the information management application.

Further, the information management application may have a voice recorder function, or another voice recorder application may acquire the voice sound record stored and managed in the mobile terminal 10.

TABLE 4

| | | |
|---|---|---|
| ENTRY | 20xx/05/XX 8:35 | BUILDING A |
| EXIT | 20xx/05/XX 19:35 | BUILDING A |
| ENTRY | 20xx/05/XX 8:37 | BUILDING A |
| EXIT | 20xx/05/XX 17:45 | BUILDING A |
| . . . | . . . | . . . |

Table 4 schematically illustrates entry-exit information stored in the entry-exit information storage unit 24. The date and time of entering or leaving (exiting) a predetermined facility are recorded in chronological order. The action history recording unit 14 records entry-exit information in conjunction with the entry exit management system at the facility of the business place to which the user belongs. For example, an information management application can record entry or exit by wireless communication such as a time recorder (connected to an attendance management system) installed in the business place. The information management application directly acquires the date and time of entry/exit and location information such as the room/building to/from which a person has entered/exited, from the time recorder. Alternatively, the aforementioned information can be acquired from an attendance management system connected to a time recorder. Entry-exit information is an example of the action history managed by the information management application.

In this case, the user performs wireless communication with the time recorder by holding the mobile terminal 10 over the time recorder when entering or leaving the room. Further, the entry exit history stored and managed by another entry exit management application may be acquired as action history data.

TABLE 5

| DATE AND TIME | POSITION INFORMATION |
|---|---|
| 20xx/05/XX hh:mm | (LATITUDE, LONGITUDE, ALTITUDE) |
| 20xx/05/XX hh:mm | (LATITUDE, LONGITUDE, ALTITUDE) |
| 20xx/05/XX hh:mm | (LATITUDE, LONGITUDE, ALTITUDE) |
| . . . | . . . |

Table 5 schematically illustrates position information stored in the movement history information storage unit 25. Position information is the periodically acquired date and time and coordinates (latitude, longitude, altitude) where the user is located. Position information is an example of the action history managed by the information management application.

TABLE 6

| | DATE AND | MEETING | |
|---|---|---|---|
| SUBJECT MATTER | TIME | PARTY | LOCATION |
| NEW SYSTEM | 20xx/05/15 | COMPANY A | COMPANY A |
| BRIEFING | 10:00~11:00 | Mr. a | |
| ACCOMMODATE | 20xx/05/10 | COMPANY B | COMPANY B |
| CLAIMS | 15:00~16:00 | Mr. b | |
| . . . | . . . | . . . | . . . |

Table 6 schematically illustrates the schedule information stored in the schedule information storage unit 26. Schedule information includes the subject matter, date and time, the meeting party (the person to meet), and the location. For example, the information management application has a scheduler function and can manage a schedule including a subject matter, a location, the start date and time, and the end date and time. Here, the location may be a station name or the name of the office or building associated with the station name. The station name and route information may be registered separately from the location. In the information management application, the action history data may be collected by acquiring the schedule information managed by another scheduler application. Schedule information is an example of the action history managed by the information management application.

### <<Communication Apparatus>>

The communication apparatus 30 includes a short range wireless communication unit 31, an information selecting unit 32, and a communication unit 33. Each of these functions of the communication apparatus 30 is a function or means implemented by CPU 601 executing a program loaded from the storage 605 to the RAM 603 illustrated in FIG. 5.

The short range wireless communication unit 31 periodically transmits radio waves to send a query as to whether the mobile terminal 10 is present in the surroundings, and when a response is received from the mobile terminal 10, the short range wireless communication unit 31 requests for a user profile and an action history. Accordingly, the short range wireless communication unit 31 receives the user profile and the action history from the mobile terminal 10.

The information selecting unit 32 selects the information to be transmitted to the information processing apparatus 50, from the action history, by referring to a document information association information storage unit 38 to be described later. That is, only the action history necessary for creating a document is transmitted from among the action history transmitted by the mobile terminal 10, and, therefore, an increase in the communication amount can be prevented.

The communication unit 33 transmits and receives various kinds of information with the information processing apparatus 50. According to the present embodiment, the information selecting unit 32 transmits the selected action history and the user profile to the information processing apparatus 50. The transmission timing can be set by the user in the user profile and can be selected as immediately, weekly, monthly, etc., after communication.

The document information association information storage unit 38 implemented by the storage 605, the ROM 602, or the RAM 603 illustrated in FIG. 5 is formed in the storage unit 39. Hereinafter, the document information association information storage unit 38 will be described.

TABLE 7

| | |
|---|---|
| TRANSPORTATION | TRAFFIC-RELATED IC CARD USAGE |
| EXPENSE | HISTORY, TRANSPORTATION EXPENSE |
| REIMBURSEMENT | RELATED ITEMS IN CREDIT CARD USAGE |
| | HISTORY (USAGE FEES OF TAXI, TOLL |
| | ROAD, ETC.), SCHEDULE, MOVEMENT |
| | HISTORY |
| CREATE DAILY | SCHEDULE, MOVEMENT HISTORY, |
| REPORT | MEETING HISTORY, ENTRY-EXIT HISTORY |
| CREATE MINUTES | SCHEDULE, MEETING HISTORY, MEETING |
| | VOICE SOUND RECORD |
| INPUT WORK | ENTRY-EXIT HISTORY, SCHEDULE, |
| RECORD | MOVEMENT HISTORY, MEETING HISTORY |

Table 7 schematically illustrates document information association information stored in the document information association information storage unit 38. The document information association information is information that associates the document to be created with the necessary action history. As illustrated in Table 7, if the document is a transportation expense reimbursement document, the traffic-related IC card usage history, transportation expense related items in the credit card usage history (usage fees of taxi, toll road, etc.), the schedule, and the movement history are necessary information for creating the document.

Accordingly, the information selecting unit 32 can determine the action history necessary for the automatic creation document set in the user profile by referring to the document information association information. The action history that is not set to be transmitted to the information processing apparatus 50 may be deleted without waiting for the transmission timing.

### <<Information Processing Apparatus>>

The information processing apparatus 50 includes a communication unit 51, an information integrating unit 52, and a document creating unit 59. Each of these functions of the information processing apparatus 50 is a function or a means implemented by the CPU 501 executing a program loaded from the HD 504 to the RAM 503 illustrated in FIG. 4.

The communication unit 51 receives the user profile and the action history that is selected transmitted from the communication apparatus 30.

When the action history of the same user is transmitted from a plurality of the communication apparatuses 30, that is, when it is determined that there are a plurality of action histories corresponding to the same identification information of a user included in the user profile, the information integrating unit 52 integrates all of the pieces of data in time series. When integrating the data, the data is rearranged and integrated in chronological order based on the time information included in the action history. For example, transportation expenses and credit card usage history can be rearranged in chronological order according to the date and time of settlement, and schedule information can be rearranged in chronological order according to the date and time the meetings are held, etc. The period of integration (closing date) is set by the user for each document.

The document creating unit 59 includes a transportation expense reimbursement document creating unit 53, a daily report creating unit 54, a minutes creating unit 55, and a work record creating unit 56. These elements are described below.

### (Creation of Transportation Expense Reimbursement Document)

(i) The transportation expense reimbursement document creating unit 53 acquires route information (entry and exit stations) and travel expense information from the traffic-related IC card usage history. The transportation expense reimbursement document creating unit 53 acquires transportation route information (including entry and exit interchange names) and information of the amount of money from credit card usage history. If there is no route information such as in the case of a taxi, only the amount of money is acquired. When the usage history is acquired from the communication apparatus 30, the acquired usage history is used, but the usage history may be acquired from the billing related server 70 of the traffic-related IC card.

(ii) The transportation expense reimbursement document creating unit 53 refers to the schedule information and position information, selects the transportation expense information that can be determined as having been used for work in the current month, and records the information in the transportation expense reimbursement document. That is, it is determined whether the location of the schedule registered in the schedule information is included in the route information, and whether the position information at the date and time in the schedule information coincides with the location in the schedule information. When these items are determined as coinciding, the transportation expense information is recorded as transportation expenses for travelling for work, in the transportation expense reimbursement document.

Further, in the case of taxi fare, it is determined whether the date and time in the schedule information coincides with the date and time in the credit card usage history, and whether the position information at the date and time in the schedule information coincides with the location in the schedule information. When these items are determined as coinciding, the transportation expense information is recorded as transportation expenses for travelling for work, in the transportation expense reimbursement document.

Further, as the purpose (abstract) of use of transportation expenses, the outing destination and the visiting destination, etc., are recorded in the transportation expense reimbursement document, based on the subject matter and the meeting party registered in the schedule information.

When the settlement date and time is included in the traffic-related IC card usage history or credit card usage history, the transportation expense reimbursement document creating unit 53 may select the transportation expense information of the month in which the form has been issued or the month specified by the user based on the settlement date and time. On the other hand, when the settlement date and time is not included in the traffic-related IC card usage history or credit card usage history, the settlement date and time may be determined by referring to other information, such as schedule information. In this case, for example, the usage history information having information coinciding with the location and start/end date included in the schedule information can be selected as “use for work in the current month”.

(iii) The transportation expense reimbursement document creating unit 53 determines a transmission destination of the transportation expense application document based on the user profile. That is, the appropriate department, budget, and review/approval route are determined based on the user's identification information. The basic settings relating to the user can be pre-registered by the user in the information processing apparatus 50. The information processing apparatus 50 manages table data in which the identification information of the user and the basic setting are associated with each other. Basic settings may also be included in the user profile.

(iv) When the predetermined closing date (end of month, etc.) has not yet approached, the transportation expense reimbursement document creating unit 53 stores the created document, and when the closing date is has approached, the transportation expense reimbursement document creating unit 53 performs a process of submitting the created document and requests for review/approval. The closing date may be included in the user profile or the basic setting.

### (Creation of Daily Report)

(i) The daily report creating unit 54 records the action of the day based on the schedule information, the movement history information, and the meeting record information, as a daily report. The daily report creating unit 54 first divides the information into “during moving” and “during staying” based on the movement history information, records the movement content in during moving, and with respect to during staying, information is transcribed to the daily report by referring to the subject matter, the date and time (start/end date and time), the meeting party, and the location included in the schedule information. In other words, the schedule that overlaps the time period during staying and that matches the position information during staying is identified. Not only schedule information but also meeting record information will be used. If there is any information that is included only in the meeting record information, such information is described. Only the information relating to the date of issuance of the form or the date specified by the user, may be described.

(ii) The daily report creating unit 54 reports the daily report mainly concerning the time of outing, to the supervisor (included in the basic setting) of the user based on the user profile. As a form of reporting, the daily report may be transmitted as mail to the mail address included in the basic setting, or the report data of the daily report may be stored and managed in the information processing apparatus 50 in a viewable manner by granting authority to a target person included in the basic setting.

### (Creation of Minutes)

(i) The minutes creation unit 55 acquires the voice sound recording data recorded at the time of the meeting based on the schedule information and the meeting history information.

(ii) The minutes creating unit 55 converts the voice sound data into text, distinguishes the user and other speakers, and records the text in association with speaker in the minutes. The voice of the user registered in the in-house system can be identified by keeping a record, but customers other than the user only need to be distinguished so as not to overlap each other, such as speaker A, speaker B, and speaker C.

(iii) The minutes creating unit 55 transmits the created minutes to the user by mail or the like or stores the minutes in a location where the user can refer to the minutes.

### (Input Work Record)

(i) The work record creating unit 56 extracts and records the check-in time and the check-out time of the day based on the entry-exit information, schedule information, movement history information, and meeting history information. If the schedule information or meeting history information does not include a record (plan) around the work start time, the entry time in the entry-exit information is the check-in time. If the schedule information or the meeting history information includes a record of around the work start time (range of around the start time is predetermined) and the movement history information includes location information that matches the location and time in the schedule information or meeting history information, the regular work start time shall be regarded as the check-in time.

Further, if there is no record (plan) around the work end time in the schedule information or the meeting history information, and the exit time is recorded in the entry-exit information, the exit time in the entry-exit information is the check-out time. If there is a record around the work end time in the schedule information or the meeting history information, and the movement history information includes location information that matches the location and time in the schedule information or the meeting history information, the time at which the movement starts from this location shall be regarded as the check-out time.

The work record creating unit 56 creates the work record of the date of issuance of the form or a day specified by the user, based on the time information included in the entry-exit information.

(ii) When overtime occurs, the work record creating unit 56 determines and records the reason for overtime based on the schedule and movement history of the day. For example, in schedule information, the subject matter and the meeting party set after the work end time (included in the basic setting) can be determined as a reason for overtime. If the schedule information indicates a schedule that overtime will definitely occur, that is, if the schedule is set after the work end time (included in the basic setting) in the schedule information, an overtime application may be automatically made.

(iii) The work record creating unit 56 sets appropriate departments, budgets, review and approval routes, etc., based on the basic settings associated with the user identification information.

(iv) When the predetermined closing date (end of month, etc.) has not yet approached, the work record creating unit 56 stores the created work record, and when the closing date is has approached, the work record creating unit 56 performs a process of submitting the created work record and requests for review/approval.

### <Operation Procedure>

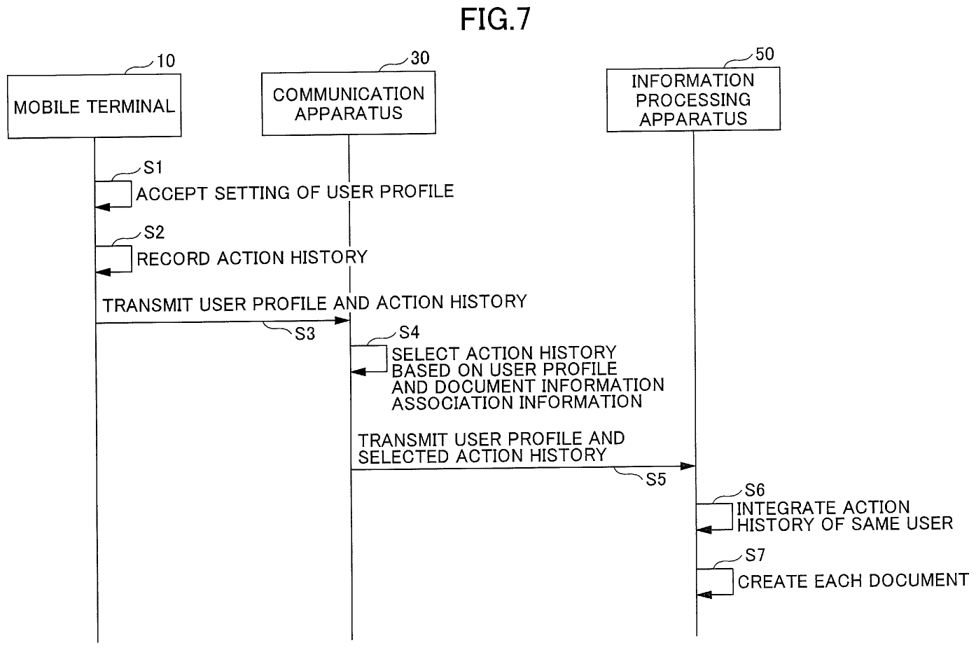

FIG. 7 is an example of a sequence diagram illustrating a procedure in which the information processing system 100 creates each document based on the user's action history.

S1: The operation accepting unit 12 of the mobile terminal 10 accepts the setting of the user profile. The user profile is to be set once for the information management application. The user profile is stored in the profile data storage unit 21.

S2: The action history recording unit 14 of the mobile terminal 10 records the action history while the information management application is running. Traffic-related IC card usage history can be recorded each time a settlement is made. Credit card usage history may be checked, for example, periodically with a credit card server, or may be recorded internally by the mobile terminal 10. For example, the meeting record information is recorded upon resuming the movement after staying for a certain period or more or upon completion of recording the voice sound data. If the position information matches the work space 9, there may be a condition of excluding the data, such as not recording the data. Voice sound data, if available, are attached to the recorded action history. Entry-exit information can be recorded at the timing when the mobile terminal 10 communicates with a timecard to report entry or exit. Alternatively, the mobile terminal 10 may communicate regularly with an attendance management system. In the movement history information, the movement information is always recorded while the information management application is running. Schedule information is set in advance by the user.

S3: When the user holds the mobile terminal 10 over the communication apparatus 30 (when the mobile terminal 10 is brought into proximity), the short range wireless communication unit 11 of the mobile terminal 10 transmits the user profile and the action history to the communication apparatus 30.

The user can transmit the action history to the information processing apparatus 50 as long as the user is at a location where the communication apparatus 30 is present, and, therefore, the user can transmit the action history and automatically create a document without moving to the company's office. The mobile terminal 10 may directly transmit the user profile and the action history to the information processing apparatus 50. In this case, the mobile terminal 10 may perform the selection of the action history.

S4: The short range wireless communication unit 31 of the communication apparatus 30 receives the user profile and the action history. The information selecting unit 32 selects the action history based on the user profile and the document information association information. Even if the user is outside the company's office, such as an outing destination, the information is selected, so that the user can transmit the action history while avoiding an increase in the communication amount.

Further, the action history includes traffic-related IC card usage history, credit card usage history, meeting record information, entry-exit information, movement history information, and schedule information. By acquiring multiple pieces of information as described above, the creation of various documents can be automated. Corresponding pieces of information can be referenced based on time, etc.

S5: The communication unit 33 of the communication apparatus 30 transmits the user profile and the selected action history to the information processing apparatus 50. The timing for transmission can be set by the user for each document.

S6: The communication unit 51 of the information processing apparatus 50 receives the user profile and the action history. First, the information integrating unit 52 integrates the action histories corresponding to the same identification information of the user in time series. The period of the integration is determined by the document. For example, the period for daily reports is one day, and the period for entry-exit information is one month, etc.

S7: At the end of the period determined for each document (for example, each time, each day, one week, one month, etc.), the transportation expense reimbursement document creating unit 53 creates a document for the transportation expense application, the daily report creating unit 54 creates a daily report, the minutes creating unit 55 creates the minutes, and the work record creating unit 56 creates a work record, based on the processing target set in the user profile.

### <Example of Document>

Hereinafter, examples of a transportation expense reimbursement document, a daily report, minutes of a meeting, and a work record will be described.

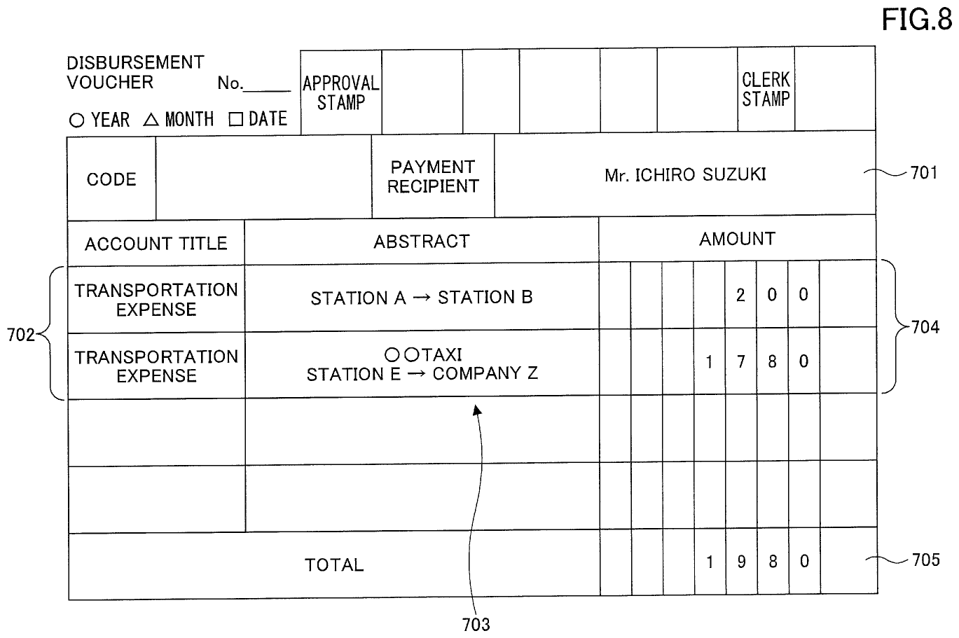

FIG. 8 illustrates an example of a transportation expense reimbursement document.

Payment recipient 701 . . . The name of the user associated with the user's identification information in the basic setting.
Account title 702 . . . Transportation expenses (fixed, as traffic-related IC card usage history or usage fees of taxi, toll road, etc., by credit card).
Abstract 703 . . . Location of entry and exit in the traffic-related IC card usage history in the transportation expense settlement information storage unit 22. Location of entry and exit relating to transportation expenses in the credit card usage history. In the case of usage history with no entry and exit records, such as taxis, the name of the shop shall be input, the movement history information shall be retrieved from the date and time of usage history, and this shall be regarded as the position information (end point) at the time of payment. The starting point shall be the position information at which the movement speed has changed from the speed of walking to the speed of a vehicle.
Amount 704 . . . Amount of travel expenses in traffic-related IC card usage history or amount in credit card usage history.
Total 705 . . . For example, the total amount in one month.

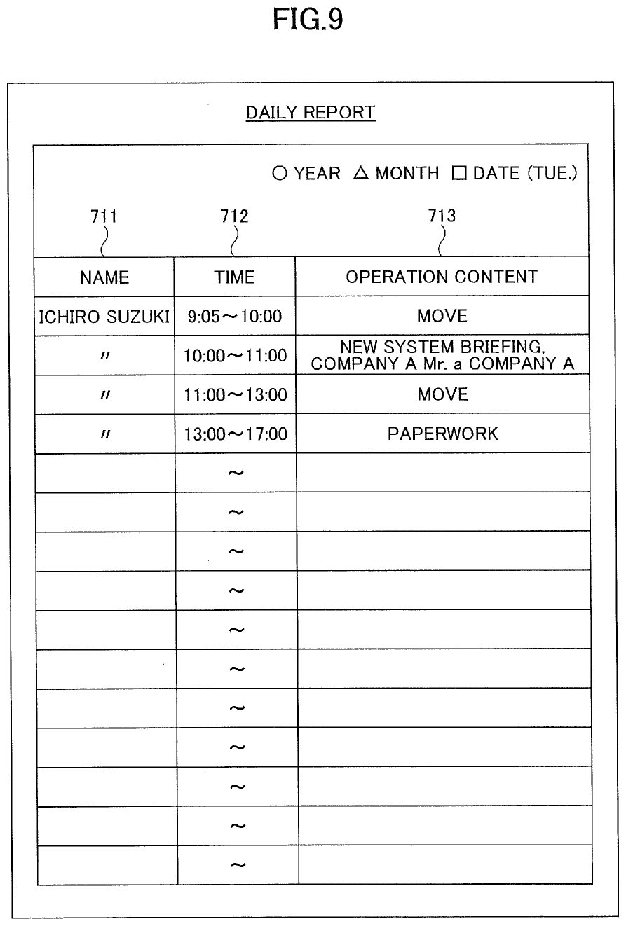

FIG. 9 illustrates an example of a daily report.

Name 711 . . . The name of the user associated with the user's identification information in the basic settings.
Time 712 . . . The start time and end time of “during moving” and “during staying” in the movement history information.
Operation content 713 . . . In the case of “during moving”, “move” is described. In the case of “during staying”, the subject matter, the meeting party, and the location in the schedule information or the meeting history information, which overlap with the time of during staying, are described. If there is no schedule information or meeting history information that overlaps with the time of during staying, a blank space or paperwork is described.

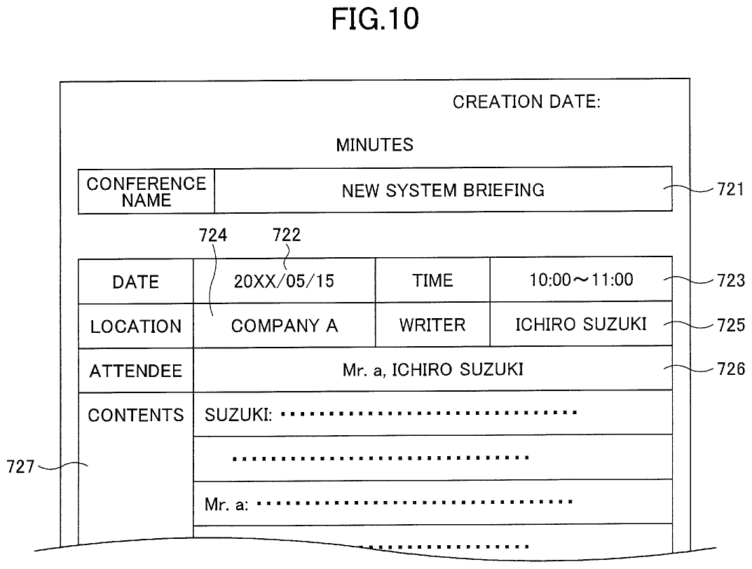

FIG. 10 illustrates an example of the minutes.

Conference name 721 . . . The subject matter of schedule information or meeting history information.
Date 722, Time 723 . . . Date and time of schedule information or meeting history information.
Location 724 . . . Location of schedule information or meeting history information.
Writer 725 . . . The name of the user associated with the user's identification information in the basic setting.
Attendee 726 . . . Meeting party in schedule information or meeting history information. The name of the user associated with the user's identification information in the basic setting.
Contents 727 . . . Text converted from voice sound data.

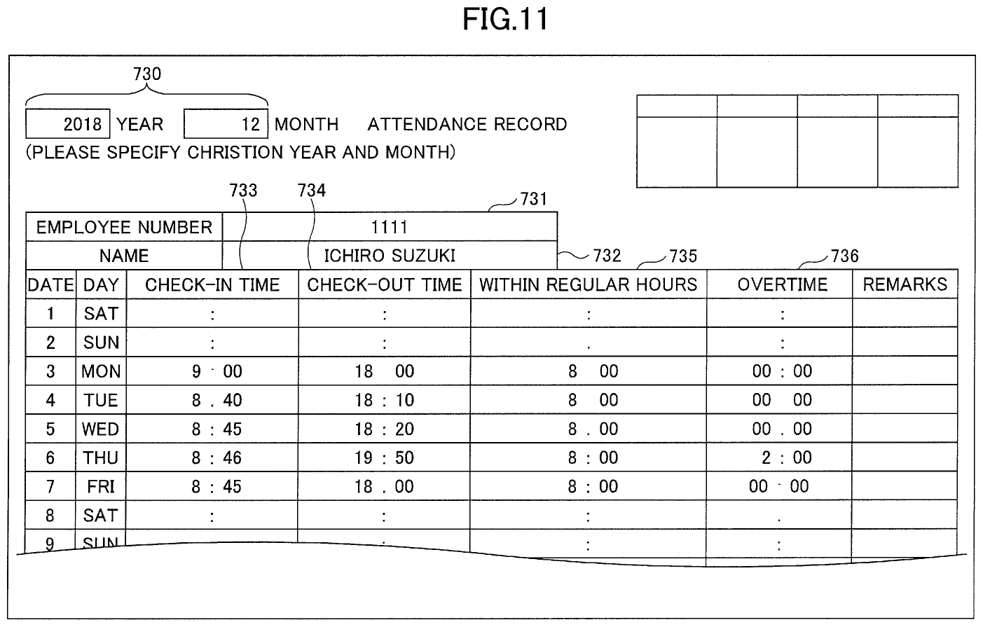

FIG. 11 illustrates an example of a work record.

Date field 730 . . . Period for aggregating work records.
Employee number 731 . . . Employee number associated with the user's identification information in the basic setting.
Name 732 . . . The name of the user associated with the user's identification information in the basic setting.
Check-in time 733 . . . Entry time in entry-exit information. However, when there is a record of around the work start time in the schedule information or the meeting history information, and the movement history information includes position information that matches the location in the schedule information or the meeting history information, the regular work start time shall be regarded as the check-in time.
Check-out time 734 . . . Exit time in entry-exit information. However, that if there is a record around the work end time in the schedule information or the meeting history information and the movement history information includes position information that matches the location in the schedule information or the meeting history information, the time at which the employee started moving from this location shall be regarded as the check-out time.
Within regular hours 735 . . . Working time from the regular work start time to the work end time. Overtime 736 . . . Working time from the regular work end time to the actual check-out time.

### [Overview]

As described above, the information processing system 100 according to the present embodiment can automatically perform various types of document creation processes even when the user is outside the company's office, such as at an outing destination. The communication apparatus 30 can prevent the increase of the communication amount by determining whether the function of the document creation process is enabled based on the user profile, selecting the action history necessary for the document creation process, and transmitting the action history to the information processing apparatus 50.

### <Other Applications>

While the preferred embodiment of the present invention has been described with reference to examples, various modifications and substitutions may be made thereto without departing from the spirit and scope of the invention.

Furthermore, the configuration example of FIG. 6, etc., indicated in the above embodiment is divided according to the main functions to facilitate the understanding of processes by the information processing system 100. However, the present invention is not limited by how the process units are divided or the names of the process units. The processes of the information processing system 100 may be further divided into many process units according to the process contents. Furthermore, the process units may be divided such that a single process unit further includes many processes.

The functions of each of the embodiments described above may be implemented by one or more processing circuits. As used herein, a “processing circuit” includes a processor programmed to execute each function by software such as a processor implemented in an electronic circuit; or devices such as an Application Specific Integrated Circuit (ASIC) a digital signal processor (DSP), a field programmable gate array (FPGA), and a conventional circuit module, designed to execute each function as described above.

Also, the apparatus group described in the examples are merely indicative of one of a plurality of computing environments for carrying out the embodiments disclosed herein.

In some embodiments, the information processing apparatus 50 includes a plurality of computing devices, such as server clusters. The plurality of computing devices are configured to communicate with each other via any type of communication link, including networks, a shared memory, and the like, and perform the processes disclosed herein.

Further, the information processing apparatus 50 may be configured to share various combinations of disclosed processing steps, such as in FIG. 7. For example, elements of the information processing apparatus 50 may be organized into a single server apparatus or may be divided into a plurality of apparatuses.

The information processing apparatus 50 may be any relevant apparatus as long as a communication function is included. The information processing apparatus 50 may be, for example, a Projector (PJ), an Interactive White Board (IWB, a whiteboard having a blackboard function capable of mutual communication), an output device such as a digital signage, a Head Up Display (HUD) device, an industrial machine, an imaging device, a sound collector, a medical device, a network appliance, a connected car, a notebook personal computer (PC), a mobile phone, a smartphone, a tablet terminal, a game machine, a Personal Digital Assistant (PDA), a digital camera, a wearable PC, a desktop PC, and the like.

According to one embodiment of the present invention, it is possible to provide an information processing apparatus or the like that is capable of automatically creating various documents even when a user is outside the company's office, such as at an outing destination.

The information processing apparatus, the document creating method, and the recording medium are not limited to the specific embodiments described in the detailed description, and variations and modifications may be made without departing from the spirit and scope of the present invention.

What is claimed is:

1. An information processing apparatus comprising:
circuitry; and
a memory storing computer-executable instructions that cause the circuitry to:
receive an action history of a user via a network from a mobile terminal recording the action history; and
create a document based on the action history.

2. The information processing apparatus according to claim 1, wherein the circuitry receives, from the mobile terminal, only the action history selected based on information specifying the document to be created.

3. The information processing apparatus according to claim 1, wherein
the circuitry receives identification information of the user together with the action history,
the action history includes a plurality of action histories corresponding to the same identification information of the user, and
the circuitry integrates all of the action histories in time series upon determining that there are the plurality of action histories corresponding to the same identification information of the user.

4. The information processing apparatus according to claim 1, wherein the action history includes at least one of a meeting history relating to the user, voice sound data of a conversation, a transportation method used for movement, a movement history, entry-exit information with respect to a predetermined facility, and a credit card usage history.

5. The information processing apparatus according to claim 1, wherein
the action history includes a traffic-related integrated circuit (IC) card usage history and a credit card usage history, and
the circuitry creates the document of transportation expense reimbursement based on the traffic-related IC card usage history and the credit card usage history.

6. The information processing apparatus according to claim 1, wherein
the action history includes a meeting history relating to the user and voice sound data obtained by recording a conversation, and
the circuitry creates minutes based on the meeting history relating to the user and the voice sound data.

7. The information processing apparatus according to claim 1, wherein
the action history includes entry-exit information with respect to a predetermined facility, schedule information, movement history information, and a meeting history relating to the user, and
the circuitry creates a work record based on the entry-exit information, the schedule information, the movement history information, and the meeting history relating to the user.

8. A document creating method performed by an information processing apparatus, the document creating method comprising:
receiving an action history of a user via a network from a mobile terminal recording the action history; and
creating a document based on the action history.

9. A non-transitory computer-readable recording medium storing a program that causes a computer to execute a process performed in an information processing apparatus, the process comprising:
receiving an action history of a user via a network from a mobile terminal recording the action history; and
creating a document based on the action history.
